(19) United States
(12) Patent Application Publication
(10) Pub. No.: US 2023/0294066 A1
(43) Pub. Date: Sep. 21, 2023

(54) PHOTOCHEMICAL REACTOR FOR SOLID PHASE SYNTHESIS

(71) Applicant: Purdue Research Foundation, West Lafayette, IN (US)

(72) Inventors: GREGORY SCOTT EAKINS, West Lafayette, IN (US); MARY LYNN NIEDRAUER, West Lafayette, IN (US); MARK A. LIPTON, Lafayette, IN (US)

(73) Assignee: Purdue Research Foundation, West Lafayette, IN (US)

(21) Appl. No.: 17/922,587

(22) PCT Filed: May 22, 2021
(86) PCT No.: PCT/US21/33793

§ 371 Date: Oct. 31, 2022

Related U.S. Application Data
(60) Provisional application No. 63/029,491, filed on May 24, 2020.

(51) Int. Cl. B01J 19/12; B01J 19/00

(52) U.S. Cl. CPC B01J 19/127; B01J 19/0013; B01J 19/0033; B01J 2219/1203; B01J 2219/0871; B01J 2219/0801

(57) ABSTRACT

A photochemical reactor is disclosed which includes a reaction chamber, the reaction chamber includes a frame, one or more circuit boards each coupled to the frame and each carrying a plurality of light sources, a power source coupling, adapted to power the one or more circuit boards, and a vial receiver centrally disposed about the one or more circuit boards. The photochemical reactor further includes an agitator configured to rotate the vial receiver.

### CROSS-REFERENCE TO RELATED APPLICATIONS

The present patent application is related to and claims the priority benefit of U.S. Provisional Patent Application Ser. No. 63/029,491, filed 24 May 2020, entitled PHOTOCHEMICAL REACTOR FOR SOLID PHASE SYNTHESIS, the contents of which are hereby incorporated by reference in its entirety into the present disclosure.

### STATEMENT REGARDING GOVERNMENT FUNDING

The innovation of the present disclosure was not made with government support.

### TECHNICAL FIELD

The present disclosure generally relates to chemical reactions, and in particular, to a reactor for photochemical transformations in organic synthesis.

### BACKGROUND

This section introduces aspects that may help facilitate a better understanding of the disclosure. Accordingly, these statements are to be read in this light and are not to be understood as admissions about what is or is not prior art.

Photochemistry, the use of electromagnetic radiation in either the visible or ultraviolet regions of the spectrum to effect chemical reactions, has grown in importance in recent decades with the increased emphasis on “green” chemistry that reduces waste products. Photochemical transformations are typically carried out by placing a suitably transparent reaction vessel into a photochemical reactor that irradiates the sample with photons of the appropriate wavelength.

Commercially available photochemical reactors consist of an enclosed cabinet in which some number of incandescent or fluorescent lamps are fitted with optical filters to select for the desired frequency. During the course of irradiation, the air temperature inside the cabinet rises as a consequence of the heat generated by the lamps, resulting in internal temperatures ranging from 37-80° C. The heating of the sample can at times lead to unwanted side reactions and cooling baths cannot be used because they interfere with the transmission of light into the reaction vessel.

Additionally, solid-phase synthesis is commonplace in chemical arts. A conventional laboratory approach to carrying out solid phase synthesis is based on two types of vessels in which reactions can take place. One class is column-type glass structure, e.g., sintered glass funnels. Another class is the glass shaker funnels. However, limitations exist in each of these types.

Generally, solid-phase synthesis is an iterative procedure that is widely used in organic and biochemistry for rapid and high purity synthesis of macromolecules with repeating units such as peptides/proteins, oligonucleotides, and complex carbohydrates The first unit of the macromolecule is covalently linked to an insoluble polymeric solid support, typically composed of polyethylene glycol or polystyrene. A linker molecule is then used to allow for release of the final product from the solid-support, generally under strongly acidic conditions.

Peptides and proteins are made up of repeating amino acid units, most of which contain highly reactive side chain functional groups. Various protecting group strategies have been developed to effectively ‘block’ these reactive groups while coupling the amino acid sequence in the C to N direction. The most commonly used approach is to employ the base-labile 9-fluorenylmethyloxycarbonyl (Fmoc) protecting group on the N-terminus of each amino acid residue while using acid-labile side chain protecting groups such as tert-butyl (t-Bu) or t-butoxycarbonyl (Boc) groups. Thus the deprotection step at each iteration can be completed under basic conditions to expose the free N-terminus without affecting any other functional groups present.

For the synthesis of C-terminally modified peptides, a method is employed to link the first residue to the solid-support through a backbone amide, allowing free access to the C-terminus for chemical transformations. This group must also be protected, generally using the acid-labile t-Bu, or palladium-labile allyl or 1,1-dimethylallyl (DMA) protecting groups. This approach faces limitations when there is a need to differentiate between any combination of the resin linkage, the acid-labile side-chain protecting groups, or the protected C-terminus.

To achieve such transformation, chemical transformations induced by irradiation with light are common in the field of organic synthesis. A wavelength must be selected which is absorbed by the material of interest. Upon absorbing photons from the light source an electron will then undergo a photoexcitation. The excited electron then goes on to react in various manners, depending on the surrounding system. The use of photochemical reactions to complete transformations in solid-phase peptide synthesis (SPPS) has grown extensively in recent years. The incorporation of photoreactive functional groups provides an added degree of chemoselectivity, allowing for selective reactions in the presence of acid- and base-reactive groups. Additionally, using light as an activator removes the need for reagents for a given chemical transformation, reducing not only the cost and waste associated with a transformation but also often eliminating the purification that typically follows standard chemical reactions. Photoreactive linkages are typically used in SPPS as either protecting groups or as linkers to the solid-support.

The equipment required to perform photochemical transformations on molecules attached to solid-support as opposed to in solution continues to pose several challenges. While the commonly used wavelengths are widely available as fluorescent bulbs, the intensity of light output is often low, resulting in long reaction times. These lamps also generate a broad range of wavelengths, further lowering the intensity of light generated at the precise wavelength needed. The lamps generally used in photochemical reactors generate high quantities of heat, even with built in convection systems. This can pose a challenge for organic synthesis, where reactions are often carried out in solvents with low boiling points. Many organic and bioorganic molecules also contain functional groups that are heat-sensitive, limiting the scope of molecules that are compatible with photochemical reactions using the currently available technology.

Furthermore, another challenge of conducting synthesis on a solid support is providing sufficient agitation to the system to ensure complete transformation with reasonable reaction times. This is due to the tendency of the insoluble resin beads to coagulate in solvent, limiting the penetration of reagents throughout the sample. The use of magnetic stirring as in traditional organic synthesis cannot be used, as the mechanical force has a tendency to mechanically degrade the polymeric resin beads. Instead, a synthesis vessel is employed consisting of a glass reaction chamber fitted with a fritted filter across the bottom. The chamber is circularly spun at low speeds, causing constant mixing of the resin slurry. Upon reaction completion, the solvent and excess reagents can be removed by filtration, leaving the resin-bound peptide behind on the filter. The need for agitation poses a challenge when conducting photochemical transformations on the solid support, as the standard solid-phase synthesis vessels are made of glass and thus partly opaque to UV radiation. Additionally, the chamber of commercially available photochemical reactors is sufficiently small and completely enclose to exclude the possibility of inserting a spinning mechanism to permit sample agitation during irradiation.

Therefore, there is an unmet need for a novel approach for photochemical transformations in solid-phase synthesis that overcomes the aforementioned shortcomings and yet provides a degree of freedom to introduce various components including agitators.

### SUMMARY

A photochemical reactor is disclosed. The photochemical reactor includes a reaction chamber. The reaction chamber includes a frame, one or more circuit boards each coupled to the frame and each carrying a plurality of light sources, a power source coupling, adapted to power the one or more circuit boards, and a vial receiver centrally disposed about the one or more circuit boards. The photochemical reactor further includes an agitator configured to rotate the vial receiver.

According to one embodiment of the photochemical reactor, the plurality of light sources are light emitting diodes (LEDs).

According to one embodiment of the photochemical reactor, the LEDs are configured to output light having a wavelength of between about 300 nm and about 400 nm.

According to one embodiment of the photochemical reactor, the LEDs are coupled to a current limiting resistor.

According to one embodiment of the photochemical reactor, the reaction chamber is structured to conduct heat away from the reaction chamber to ambient air.

According to one embodiment of the photochemical reactor, the frame is a metallic structure.

According to one embodiment of the photochemical reactor, the material of the metallic structure is selected from the group consisting of copper, aluminum, steel, and alloys thereof.

According to one embodiment of the photochemical reactor, the one or more circuit boards are disposed in a cylindrical configuration, wherein the light sources are pointing inwardly towards the vial receiver.

According to one embodiment of the photochemical reactor, each of the current limiting resistors are disposed adjacent an opening thermally coupled to ambient air.

According to one embodiment of the photochemical reactor, each of the openings is adjacent to each of the one or more circuit boards forming an elongated opening in the frame.

According to one embodiment of the photochemical reactor, the photochemical reactor further includes one or more photodetectors disposed about the vial receiver and adapted to measure wavelength of incident light at the vial receiver, and a controller. The controller is configured to receive feedback signals from the one or more photodetectors, establish an error associated with a desired wavelength at the vial receiver and the measured wavelength, apply an error minimization regression algorithm to minimize the wavelength error, and selectively activate one or more of the plurality of light sources, wherein the plurality of light source are provided in one or more banks, where each bank represent a predetermined wavelength.

According to one embodiment of the photochemical reactor, the photochemical reactor further includes one or more temperature sensors disposed about the vial receiver and adapted to measure temperature of air about the vial receiver, a cooling fan system, and a controller. The controller is configured to receive feedback signals from the one or more temperature sensors, establish an error associated with a desired air temperature about the vial receiver and the measured temperature, apply an error minimization regression algorithm to minimize the temperature error, and control the air temperature by one of i) selectively control speed of the cooling fan system, ii) selectively control intensity of the plurality of light sources, or iii) a combination of (i) and (ii).

A method of providing a photochemical reaction is also disclosed. The method includes placing a sample in vial positioned in vial receiver within a photoreaction chamber. The photoreaction chamber includes a frame, one or more circuit boards each coupled to the frame and each carrying a plurality of light sources, and a power source coupling, adapted to power the one or more circuit boards. The vial receiver centrally disposed about the one or more circuit boards and configured to be rotated to thereby provide agitation of the sample within the vial. The method also includes energizing the one or more circuit boards to thereby illuminate the plurality of the light sources, and rotating the vial receiver.

According to one embodiment of the method, the plurality of light sources are light emitting diodes (LEDs).

According to one embodiment of the method, the LEDs are configured to output light having a wavelength of between about 300 nm and about 400 nm.

According to one embodiment of the method, the LEDs are coupled to a current limiting resistor.

According to one embodiment of the method, the reaction chamber is structured to conduct heat away from the reaction chamber to ambient air.

According to one embodiment of the method, the frame is a metallic structure.

According to one embodiment of the method, the material of the metallic structure is selected from the group consisting of copper, aluminum, steel, and alloys thereof.

According to one embodiment of the method, the one or more circuit boards are disposed in a cylindrical configuration, wherein the light sources are pointing inwardly towards the vial receiver.

According to one embodiment of the method, each of the current limiting resistors are disposed adjacent an opening thermally coupled to ambient air.

According to one embodiment of the method, each of the openings is adjacent to each of the one or more circuit boards forming an elongated opening in the frame.

According to one embodiment of the method, the method further includes measuring wavelength of incident light at the vial receiver by one or more photodetectors disposed about the vial receiver, receiving feedback signals from the one or more photodetectors by a controller, the controller establishing an error associated with a desired wavelength at the vial receiver and the measured wavelength, the controller applying an error minimization regression algorithm to minimize the wavelength error, and the controller selectively activating one or more of the plurality of light sources, wherein the plurality of light source are provided in one or more banks, where each bank represent a predetermined wavelength.

According to one embodiment of the method, the method further includes measuring temperature of air about the vial receiver by one or more temperature sensors disposed about the vial receiver, injecting air into the frame by a cooling fan system, receiving feedback signals from the one or more temperature sensors by a controller, the controller establishing an error associated with a desired air temperature about the vial receiver and the measured temperature, the controller applying an error minimization regression algorithm to minimize the temperature error, and the controller controlling the air temperature by one of i) selectively control speed of the cooling fan system, ii) selectively control intensity of the plurality of light sources, or iii) a combination of (i) and (ii).

### BRIEF DESCRIPTION OF DRAWINGS

FIG. 1 is an exploded perspective view of a photochemical reactor according to the present disclosure for conducting photochemical transformations on photosensitive reactants, including a printed circuit board (PCB) holder.

FIG. 2 is a perspective view of a PCB holder, according to one embodiment of the present disclosure.

FIG. 3 is a top view of the PCB holder, according to one embodiment of the present disclosure.

FIG. 4 is a cross sectional view of the PCB holder, according to one embodiment of the present disclosure.

FIG. 5 is a top view of the PCB holder, according to one embodiment of the present disclosure.

FIG. 6 is the exploded perspective view of the photochemical reactor of FIG. 1 according to the present disclosure including a cooling fan.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

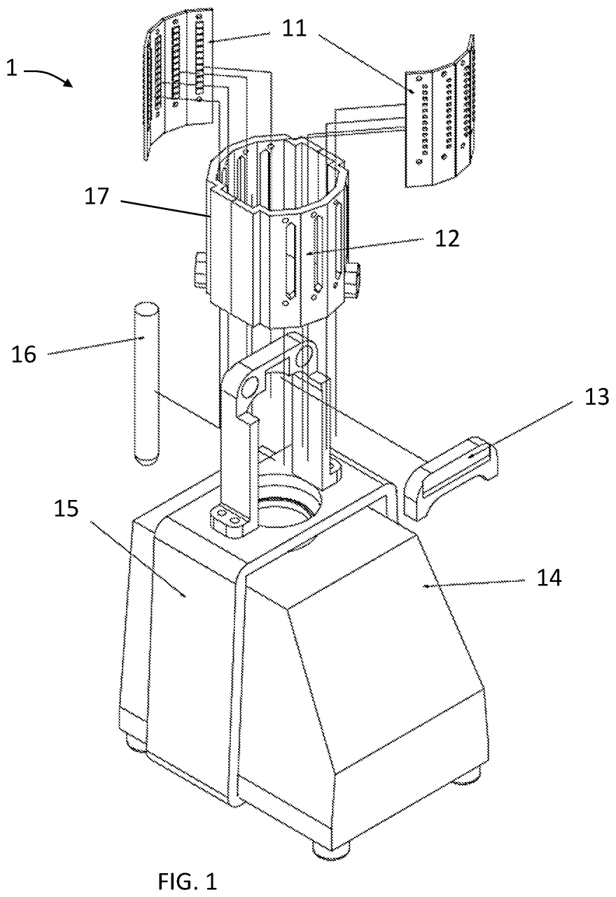

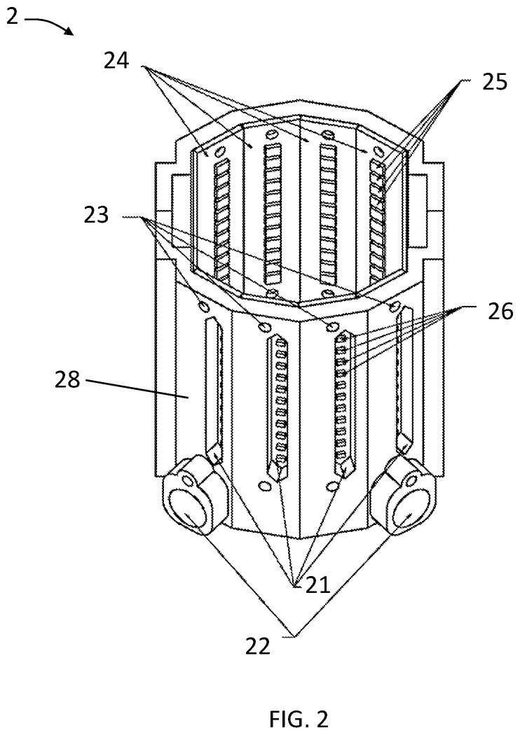

A novel approach is described in the present disclosure for photochemical transformations in solid-phase synthesis. To this end, referring to FIG. 1, a photochemical reactor 1 is shown for conducting photochemical transformations on photosensitive reactants. The photochemical reactor 1 includes a cylindrically-shaped chamber 17, in the center of which is a vial holder which can hold a sealed vial 16 containing a sample, including a solvent and desired photosensitive reactants. The chosen vial material of the vial 16 is optically transparent to the required wavelength of the chemical reaction. The photochemical reactor 1 further includes Printed Circuit Boards (PCBs) 11 designed to mount Light Emitting Diodes (LEDs) (see LEDs 25 in FIG. 2) selected to coincide with the required wavelength of the reaction. PCBs 11 are configured to transport heat away from an inner portion of the chamber 17 by conduction to prevent over-heating of the sample in the vial 16. The photochemical reactor 1 also includes a chamber frame 12. The PCBs 11 are mounted to the chamber frame 12 in a concentric fashion to allow radial photo-radiation towards the center of the chamber 17 where the vial 16 is located. The chamber frame 12 is constructed of a thermally conductive material such as copper, aluminum or steel, or other metals to provide a thermal reservoir that sinks heat away from the PCBs 11 and radiates that heat to the surrounding environment.

Each PCB 11 is mounted on an arc normal to the center of the chamber frame 12; the center of the chamber frame 12 is where the vial 16 is held in place. This orientation serves to maximize light intensity on the sample since LED luminous intensity peaks orthogonal to the mounting surface of the LEDs (see LEDs 25 in FIG. 2).

The photochemical reactor 1 also includes a continuous duty agitator unit 14 capable of rotating the base of the vial 16 and therefore the sample therein at a rate fast enough to agitate the sample into a homogeneous mixture that can be evenly irradiated in the photochemical reactor 1.

The photochemical reactor 1 further includes a frame 15 that provides support for the remainder of components of the photochemical reactor 1. The frame 15 is produced, e.g., through injection molding, extrusion, subtractive machining, or additive manufacturing or a combination thereof into a rigid configuration. The frame 15 may optionally be constructed of a material that is reflective to the wavelength of light used in the chamber frame 12 if reduced temperatures are desired.

The photochemical reactor 1 may also include a sample cap 13 which allows for the vial 16 to be loaded and unloaded from the photochemical reactor 1 as needed. Design of the sample cap 13 conforms to the contours of the vial 16 while leaving sufficient room for movement of the vial 16 in the photochemical reactor 1 for agitation.

Referring to FIG. 2, a perspective view of a PCB holder 2 is shown, according to one embodiment of the present disclosure. The PCB holder 2 includes a plurality of PCBs 24 each PCB 24 of the plurality having a plurality of LEDs 25. Each LED 25 or groups of LEDs 25 are coupled to a current limiting resistor 26 in order to properly operate the LEDs 25, as it is known to a person having ordinary skill in the art. The current limiting resistors 26 can be positioned between a high-side voltage source 22 and the LEDs 25 or between the LEDs 25 and a low-side source (not shown), e.g., ground. The PCB holder 2 includes a frame 28 with slots 21 disposed thereon which includes mounting holes 23 for mounting the PCBs 24. The slots allow for heat generated by the current limiting resistors 26 to escape.

The PCB holder 2 and the aforementioned components constitute the reaction chamber of the present disclosure.

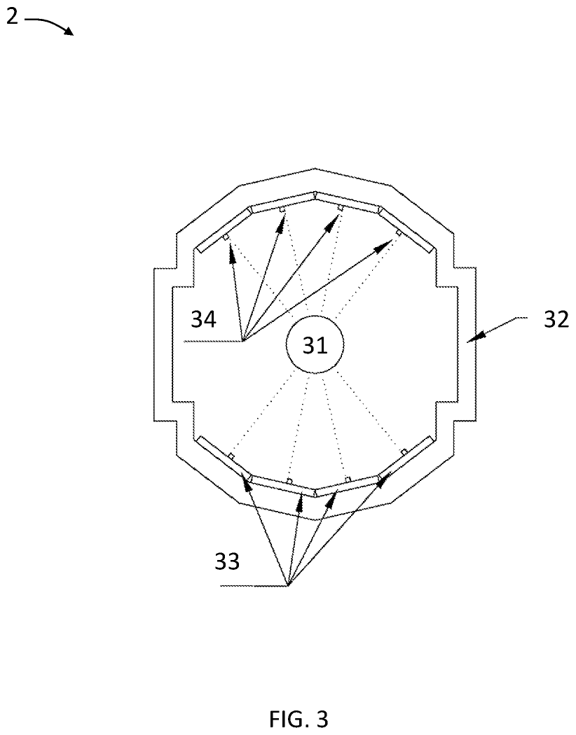

Referring to FIG. 3, a top view of the PCB holder 2 is shown, according to one embodiment of the present disclosure. As discussed above, the PCB holder 2 includes a frame 32 which holds a plurality of PCBs 33 each having a plurality of LEDs 34. A vial 31 is shown in the center of the PCB holder 2. The frame 32 can be made of a thermally conductive material such as aluminum, copper, or steel to which the PCBs 33 can be mounted.

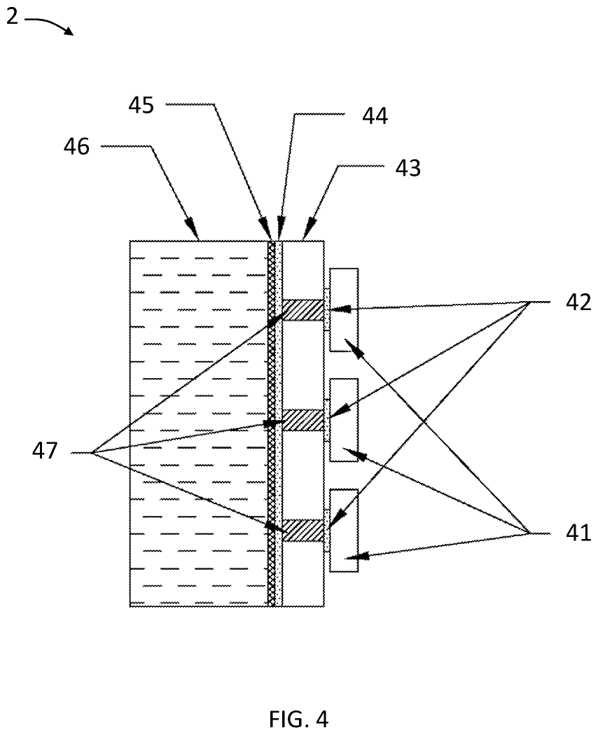

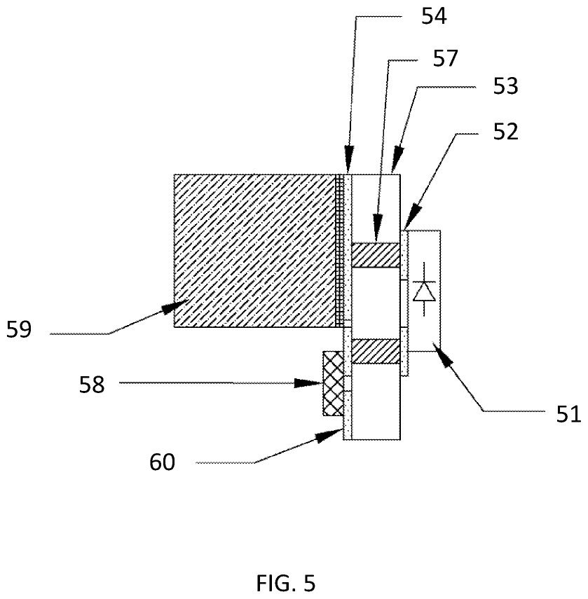

Referring to FIGS. 4 and 5, a cross sectional view and a top view of the PCB holder 2 are shown, respectively. Radiation generated by LEDs is focused on the sample by use of flat surfaces for mounting standard rigid PCBs 43 such that a line normal to the surface 42 intersects with the sample location 41.

Each PCB has mounting pads allow for LEDs of the desired wavelength to be mounted (see FIG. 2). These commonly output in the ultraviolet region of the electromagnetic spectrum (wavelength <400 nm), but may optionally be selected to output in the visible or infrared range. Light intensity scales linearly with the number of LEDs mounted in the design.

The PCBs may optionally be equipped with a temperature sensor or thermocouple to provide feedback on chamber temperatures. This feedback can be used to provide temperature control about a fixed setpoint, or a temperature shutoff if the temperature rises above a desired threshold.

The photoreactor PCBs incorporate a thermal scavenging design that utilizes PCB manufacturing techniques and design features to keep temperatures on the inside surface of the PCB and therefore the inside of the photochemical reactor 1 to a minimum. Heat generated by the LEDs flows into the copper pad at the cathode of each LED then through the PCB using metal filled holes (vias) 47, as shown in FIG. 4. The heat is diffused over a bare copper surface 44 on the back of the PCB and is then conducted to a metal frame 46 through an optional thermally conductive paste 45. Electrically, voltage is applied on the back side 60 of the PCB 54 which is mounted on the frame 53 (see FIG. 5) where it flows through a current limiting resistor 58 (see FIG. 5), then through a via to the anode of the LED 51 (see FIG. 5). The return current flows out of the cathode of the LED into a copper pad 52, through a via 57, and out to a ground plane on the back side of the PCB 54. The heat conductive frame 59 (shown in FIG. 5) is designed with a cutout to allow heat to flow from the current limiting resistors to the surrounding ambient air.

According to the present disclosure, a new photochemical reactor that can be used for a photolabile backbone amide linker, 2-hydroxyl-4-carboxy-6-nitrobenzene (Hcnb) has been described which is stable to strongly acidic conditions and which can release the completed peptide through photolytic cleavage at 350-365 nm wavelength. The photocleavable Hcnb linker was employed to test the ability of this system of the present disclosure to efficiently complete photochemical transformations when compared with commercially available instruments. The photocleavable linker was used in conjunction with the acid-labile SIEBER AMIDE linker to test the degree of completion for the photocleavage (table 1). The conditions used were as follows: polyethylene glycol or polystyrene resin with 3-10 assorted amino acid residues attached, suspended in 5 mL of solvent consisting of 90% methylene chloride and 10% methanol in a fused-quartz tube. The photochemical reactor used for comparison purposes was a RAYONET fitted with 350 nm lamps. Only trace quantities of product were detected following 24 hours of irradiation. Additionally, measured reaction chamber temperatures reached up to 80° C., causing rapid evaporation of the solvent when a completely airtight system was not utilized. In contrast, 100% cleavage and 90% overall synthetic yield were achieved with up to 230 mg of resin (largest quantity tested) in under 1 hour with the LED-UV reactor design disclosed herein, fitted with 365 nm LEDs.

TABLE 1
Comparison of cleavage times with commercially
available RAYONET photochemical reactor

| | RAYONET | | LED | | LED | |
|---|---|---|---|---|---|---|
| | Reactor | | Reactor | | Reactor | |
| Wavelength | 350 | nm | 365 | nm | 365 | nm |
| Irradiation Time | 24 | hours | 1 | h | 1 | h |
| Resin Quantity | 70 | mg | 42 | mg | 230 | mg |

| | | | |
|---|---|---|---|
| % Peptide | Trace | 100% | 100% |
| Cleavage | | | |
| Peptide | H-Phe-Ala- | H-Phe-Leu- | Cyclo[Arg-(D)- |
| | Ala-OtBu | Ala-OtBu | Phe-Pro-Glu- |
| | | | Asp-Asn-Tyr- |
| | | | Glu-Ala-Ala] |

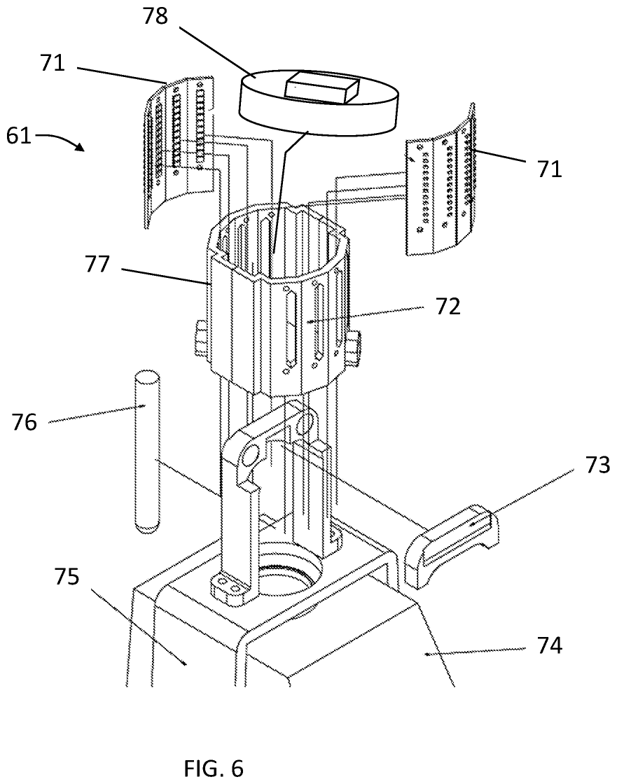

According to one embodiment of the present disclosure, a cooling system is integrated with the photochemical reactor. Referring to FIG. 6, an exploded perspective view of a top portion of a photochemical reactor 61 is shown similar to the photochemical reactor 1 of FIG. 1 which again includes a cylindrically-shaped chamber 77, in the center of which is a vial holder which can hold a sealed vial 76 containing a sample, including a solvent and desired photosensitive reactants. Similar to the photochemical reactor 1 of FIG. 1, the photochemical reactor 61 further includes PCBs 71 with mounted LEDs (not shown) of different wavelengths selected to coincide with the required wavelength of the reaction, and which have selectable output intensity. The LEDs (not shown) are provided in alternating banks each designed to provide a different wavelength. For example, on each PCB 71 there may be several banks of LEDs (not shown) where each bank is designed to provide a certain wavelength and each bank can be selectively activated at a desired intensity level. The reason for the aforementioned variety of LEDs (not shown) having different wavelengths is to use a regression technique, known to a person having ordinary skill in the art, e.g., least squares, in order to minimize resulting wavelengths at the vial 76 (see below) when activating LEDs (not shown). In order to minimize such errors, photodetectors (not shown) are applied to or near the vial 76 in order to measure the incident light, with outputs of the photodetectors (not shown) provided to a controller (not shown). When the incident light produces a wavelength that is different than a desired wavelength (i.e., there is an error), then the aforementioned regression technique performed by software within the controller utilizing data from the photodetectors determines the proper set of LEDs (not shown) to be activated in order to minimize the error and thus provide the desired wavelength. The aforementioned photodetectors (not shown) may include photomultiplier tubes with calorimeters adapted to measure the energy of particles such as photons, wherein a series of detectors are used as counters where the energy of photons is measured by conversion into electrical charge, which is then measured to determine wavelength, as is known to a person having ordinary skill in the art. In addition to photodetectors (not shown), temperature sensors (not shown) can also be mounted about the vial 76 so that temperature data within the vial can be passed on to the controller (not shown) responsible for maintaining temperature of the reactants at or below a desired level, as further described below.

Similar to the photochemical reactor 1 of FIG. 1, PCBs 71 are configured to transport heat away from an inner portion of the chamber 77 by conduction to prevent over-heating of the sample in the vial 76. The photochemical reactor 61 also includes a chamber frame 72. The chamber frame 72 is constructed of a thermally conductive material such as copper, aluminum or steel, or other metals to provide a thermal reservoir that sinks heat away from the PCBs 71 and radiates that heat to the surrounding environment. As before, each PCB 71 is mounted on an arc normal to the center of the chamber frame 72; the center of the chamber frame 72 is where the vial 76 is held in place to thereby maximize light intensity on the sample. The photochemical reactor 61 also includes a continuous duty agitator unit 74 capable of rotating the base of the vial 76 and therefore the sample therein at a rate fast enough to agitate the sample into a homogeneous mixture that can be evenly irradiated in the photochemical reactor 71. As before, the photochemical reactor 61 further includes a frame 75 that provides support for the remainder of components of the photochemical reactor 71. Similarly, the photochemical reactor 61 may also include a sample cap 73 which allows for the vial 76 to be loaded and unloaded from the photochemical reactor 61 as needed.

However, the photochemical reactor 61 shown in FIG. 6 differs from the photochemical reactor 1 of FIG. 1 in that a cooling system 78 is integrated therein. In particular, as discussed above temperature sensors (not shown) are distributed about the vial 76 so as to provide feedback signals to the controller (not shown) as to the temperature of the vial 76. These signals can then be used by the controller (not shown) to activate the cooling fan 78 at a desired speed. The cooling fan system 78 injects air into the chamber 77 in order to apply heat transfer from the vial 76 via convection. The injected air cools the vial 76 and thus prevents overheating of the material therein which represents a significant issue in the prior art photochemical reactors of the prior art. The controller provides two modes of feedback control when presented with the temperature feedback data from the temperature sensors: 1) adjust the speed of the cooling fan system 78; and 2) adjust the intensity of the activated LEDs (not shown). As in with the wavelength control discussed above, an error minimization algorithm, e.g., a regression algorithm, can be used to minimize the error between the measured temperature and the desired temperature by selectively controlling one of (i) speed of the cooling fan system, ii) intensity of the plurality of the LEDs (not shown), or iii) a combination of (i) and (ii).

Thus, the controller (not shown) of the photochemical reactor 61 shown in FIG. 6 is capable of selectively activating banks of LEDs (not shown) in response to feedback signals from the photodetectors (not shown) mounted about the vial 76 as well as selectively controlling the speed of the cooling fan system 78 and the intensity of the activated LEDs in order to achieve a desired wavelength at the vial 76 as well as a desired temperature at the vial 76.

Those having ordinary skill in the art will recognize that numerous modifications can be made to the specific implementations described above. The implementations should not be limited to the particular limitations described. Other implementations may be possible.

1. A photochemical reactor, comprising:
a reaction chamber, including:
a frame;
one or more circuit boards each coupled to the frame and each carrying a plurality of light sources;
a power source coupling, adapted to power the one or more circuit boards;
a vial receiver centrally disposed about the one or more circuit boards; and
an agitator configured to rotate the vial receiver.

2. The photochemical reactor of claim 1, wherein the plurality of light sources are light emitting diodes (LEDs).

3. The photochemical reactor of claim 2, wherein the LEDs are configured to output light having a wavelength of between about 300 nm and about 400 nm.

4. The photochemical reactor of claim 2, wherein the LEDs are coupled to a current limiting resistor.

5. The photochemical reactor of claim 1, wherein the reaction chamber is structured to conduct heat away from the reaction chamber to ambient air.

6. The photochemical reactor of claim 5, wherein the frame is a metallic structure.

7. The photochemical reactor of claim 6, wherein material of the metallic structure is selected from the group consisting of copper, aluminum, steel, and alloys thereof.

8. The photochemical reactor of claim 1, wherein the one or more circuit boards are disposed in a cylindrical configuration, wherein the light sources are pointing inwardly towards the vial receiver.

9. The photochemical reactor of claim 1, further comprising:
one or more photodetectors disposed about the vial receiver and adapted to measure wavelength of incident light at the vial receiver; and
a controller configured to:
receive feedback signals from the one or more photodetectors;
establish an error associated with a desired wavelength at the vial receiver and the measured wavelength;
apply an error minimization regression algorithm to minimize the wavelength error; and
selectively activate one or more of the plurality of light sources, wherein the plurality of light source are provided in one or more banks, where each bank represent a predetermined wavelength.

10. The photochemical reactor of claim 1, further comprising:
one or more temperature sensors disposed about the vial receiver and adapted to measure temperature of air about the vial receiver;
a cooling fan system; and
a controller configured to:
receive feedback signals from the one or more temperature sensors;
establish an error associated with a desired air temperature about the vial receiver and the measured temperature;
apply an error minimization regression algorithm to minimize the temperature error; and
control the air temperature by one of i) selectively control speed of the cooling fan system, ii) selectively control intensity of the plurality of light sources, or iii) a combination of (i) and (ii).

11. A method of providing a photochemical reaction, comprising:
placing a sample in vial positioned in vial received within a photoreaction chamber, the photoreaction chamber including:
a frame;
one or more circuit boards each coupled to the frame and each carrying a plurality of light sources;
a power source coupling, adapted to power the one or more circuit boards;
the vial receiver centrally disposed about the one or more circuit boards and configured to be rotated to thereby provide agitation of the sample within the vial;
energizing the one or more circuit boards to thereby illuminate the plurality of the light sources; and
rotating the vial receiver.

12. The method of claim 11, wherein the plurality of light sources are light emitting diodes (LEDs).

13. The method of claim 12, wherein the LEDs are configured to output light having a wavelength of between about 300 nm and about 400 nm.

14. The method of claim 12, wherein the LEDs are coupled to a current limiting resistor.

15. The method of claim 11, wherein the reaction chamber is structured to conduct heat away from the reaction chamber to ambient air.

16. The method of claim 15, wherein the frame is a metallic structure.

17. The method of claim 16, wherein material of the metallic structure is selected from the group consisting of copper, aluminum, steel, and alloys thereof.

18. The method of claim 11, wherein the one or more circuit boards are disposed in a cylindrical configuration, wherein the light sources are pointing inwardly towards the vial receiver.

19. The method of claim 11, further comprising:
measuring wavelength of incident light at the vial receiver by one or more photodetectors disposed about the vial receive;
receiving feedback signals from the one or more photodetectors by a controller;
the controller establishing an error associated with a desired wavelength at the vial receiver and the measured wavelength;
the controller applying an error minimization regression algorithm to minimize the wavelength error; and
the controller selectively activating one or more of the plurality of light sources, wherein the plurality of light source are provided in one or more banks, where each bank represent a predetermined wavelength.

20. The method of claim 11, further comprising:
measuring temperature of air about the vial receiver by one or more temperature sensors disposed about the vial receive;
injecting air into the frame by a cooling fan system;
receiving feedback signals from the one or more temperature sensors by a controller;
the controller establishing an error associated with a desired air temperature about the vial receiver and the measured temperature;
the controller applying an error minimization regression algorithm to minimize the temperature error; and
the controller controlling the air temperature by one of i) selectively control speed of the cooling fan system, ii) selectively control intensity of the plurality of light sources, or iii) a combination of (i) and (ii).
